(19) United States
(12) Patent Application Publication
(10) Pub. No.: US 2020/0356802 A1
(43) Pub. Date: Nov. 12, 2020

(54) IMAGE PROCESSING METHOD AND APPARATUS, ELECTRONIC DEVICE, STORAGE MEDIUM, AND PROGRAM PRODUCT

(71) Applicant: SHENZHEN SENSETIME TECHNOLOGY CO., LTD., Shenzhen (CN)

(72) Inventors: Hengshuang ZHAO, SHENZHEN (CN); Yi ZHANG, SHENZHEN (CN); Jianping SHI, SHENZHEN (CN)

(21) Appl. No.: 16/905,478

(22) Filed: Jun. 18, 2020

Related U.S. Application Data
(63) Continuation of application No. PCT/CN2019/093646, filed on Jun. 28, 2019.

(30) Foreign Application Priority Data
Aug. 7, 2018 (CN) 201810893153.1

(51) Int. Cl. G06K 9/46; G05D 1/02; G06N 20/00

(52) U.S. Cl. CPC G06K 9/4671; G06N 20/00; G05D 1/0231

(57) ABSTRACT

Embodiments of the present application provide an image processing method and apparatus, an electronic device, a storage medium, and a program product. The method includes: generating a feature map of a to-be-processed image by performing feature extraction on the image; determining a feature weight corresponding to each of a plurality of feature points comprised in the feature map; and obtaining a feature-enhanced feature map by separately transmitting feature information of each feature point to associated other feature points comprised in the feature map based on the corresponding feature weight.

### CROSS REFERENCE TO RELATED APPLICATIONS

This application is a continuation of International Application No. PCT/CN2019/093646, filed on Jun. 28, 2019, which claims priority to Chinese Patent Application No. CN 201810893153.1, entitled “IMAGE PROCESSING METHOD AND APPARATUS, ELECTRONIC DEVICE, STORAGE MEDIUM, AND PROGRAM PRODUCT”, and filed with the Chinese Patent Office on Aug. 7, 2018, all of which are incorporated herein by reference in their entirety.

### TECHNICAL FIELD

The present application relates to machine learning technologies, and in particular, to image processing methods and apparatuses, electronic devices, storage mediums, and program products.

### BACKGROUND

To enable a computer to “understand” an image and thus have a “vision” in true sense, it is necessary to extract useful data or information from the image to obtain “non-image” representations or descriptions of the image, such as values, vectors, and symbols. This process is feature extraction, and these extracted “non-image” representations or descriptions are features. With these features in a numerical value or vector form, the computer can be taught, through a training process, how to understand these features, so that the computer is capable of recognizing the image.

The feature is a corresponding (essential) feature or characteristic that distinguishes one type of objects from another type of objects, or is a set of features and characteristics. The feature is data that can be extracted through measurement or processing. For images, each image has its own features that can be distinguished from other types of images. Some of the features are natural features that can be visually perceived, such as brightness, edges, texture, and color, and some of the features are obtained through transformation or processing, such as histograms and principal components.

### SUMMARY

Embodiments of the present application provide an image processing technology.

An image processing method provided according to one aspect of the embodiments of the present application includes:

generating a feature map of a to-be-processed image by performing feature extraction on the image;

determining a feature weight corresponding to each of a plurality of feature points comprised in the feature map; and

obtaining a feature-enhanced feature map by separately transmitting feature information of each feature point to associated other feature points comprised in the feature map based on the corresponding feature weight.

An image processing apparatus provided according to another aspect of the embodiments of the present application includes:

a feature extraction unit, configured to generate a feature map of a to-be-processed image by performing feature extraction on the image;

a weight determination unit, configured to determine a feature weight corresponding to each of a plurality of feature points comprised in the feature map; and

a feature enhancement unit, configured to obtain a feature-enhanced feature map by separately transmitting feature information of each feature point to associated other feature points comprised in the feature map based on the corresponding feature weight.

An electronic device provided according to another aspect of the embodiments of the present application includes a processor, where the processor includes the image processing apparatus according to any one of the embodiments above.

An electronic device provided according to another aspect of the embodiments of the present application includes: a processor; and a memory, storing instructions executable by the processor, where the processor is configured to execute the instructions to implement the image processing method according to any one of the embodiments above.

A non-volatile computer storage medium provided according to another aspect of the embodiments of the present application, the storage medium stores computer-readable instructions that, when executed by a processor, cause the processor to implement the image processing method according to any one of the embodiments above.

A computer program product provided according to another aspect of the embodiments of the present application, the computer program product includes a computer-readable code, where when the computer-readable code runs in a device, a processor in the device executes instructions for implementing the image processing method according to any one of the embodiments above.

Based on the image processing method and apparatus, the electronic device, the storage medium, and the program product provided by the embodiments of the present application, feature extraction is performed on a to-be-processed image to generate a feature map of the image, a feature weight corresponding to each of multiple feature points included in the feature map is determined, and feature information of each feature point is transmitted to multiple associated other feature points included in the feature map based on the corresponding feature weight, thus, a feature-enhanced feature map is obtained. Information is transmitted between feature points, so that context information can be better used, and the feature-enhanced feature map includes more information.

The technical solutions of the present disclosure are further described below in detail with reference to the accompanying drawings and embodiments.

### BRIEF DESCRIPTION OF THE DRAWINGS

The accompanying drawings constituting a part of the specification describe the embodiments of the present disclosure and are intended to explain the principles of the present disclosure together with the descriptions.

According to the following detailed descriptions, the present disclosure may be understood more clearly with reference to the accompanying drawings.

FIG. 1 is a flowchart of one embodiment of an image processing method according to the present application.

FIG. 2 is a schematic diagram of information transmission between feature points in an optional example of an image processing method according to the present application.

FIG. 3 is a schematic diagram of a network structure of another embodiment of an image processing method according to the present application.

FIG. 4-a is a schematic diagram of obtaining a weight vector of an information collect branch in another embodiment of an image processing method according to the present application.

FIG. 4-b is a schematic diagram of obtaining a weight vector of an information distribute branch in another embodiment of an image processing method according to the present application.

FIG. 5 is an exemplary schematic structural diagram of network training in an image processing method according to the present application.

FIG. 6 is another exemplary schematic structural diagram of network training in an image processing method according to the present application.

FIG. 7 is a schematic structural diagram of one embodiment of an image processing apparatus according to the present application.

FIG. 8 is a schematic structural diagram of an electronic device suitable for implementing a terminal device or a server according to embodiments of the present application.

### DETAILED DESCRIPTION

Various exemplary embodiments of the present disclosure are now described in detail with reference to the accompanying drawings. It should be noted that, unless otherwise stated specifically, relative arrangement of the components, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative, and are not intended to limit the present disclosure and applications or uses thereof.

Technologies, methods, and devices known to a person of ordinary skill in the related art may not be discussed in detail, but such technologies, methods, and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to computer systems/servers, which may operate with numerous other general-purpose or special-purpose computing system environments or configurations. Examples of well-known computing systems, environments, and/or configurations suitable for use together with the computer systems/servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems, and the like.

The computer systems/servers may be described in the general context of computer system executable instructions (for example, program modules) executed by the computer system. Generally, the program modules may include routines, programs, target programs, components, logics, data structures, and the like for performing specific tasks or implementing specific abstract data types. The computer systems/servers may be practiced in the distributed cloud computing environments in which tasks are performed by remote processing devices that are linked through a communications network. In the distributed computing environments, the program modules may be located in local or remote computing system storage media including storage devices.

FIG. 1 is a flowchart of one embodiment of an image processing method according to the present application. As shown in FIG. 1, the method according to the embodiments includes the following steps.

At step 110, feature extraction is performed on a to-be-processed image to generate a feature map of the image.

The image in the embodiments is an image that has not undergone feature extraction processing, or is a feature map or the like that is obtained after feature extraction is performed for one or more times. A specific form of the to-be-processed image is not limited in the present application.

In one optional example, step S110 may be performed by a processor by invoking a corresponding instruction stored in a memory, or may be performed by a feature extraction unit 71 (as shown in FIG. 7) run by the processor.

At step 120, a feature weight corresponding to each of a plurality of feature points included in the feature map is determined.

The multiple feature points in the embodiments are all or some of the feature points in the feature map. To implement information transmission between feature points, a transmission probability needs to be determined. That is, all or a part of information of one feature point is transmitted to another feature point, and a transmission ratio is determined by a feature weight.

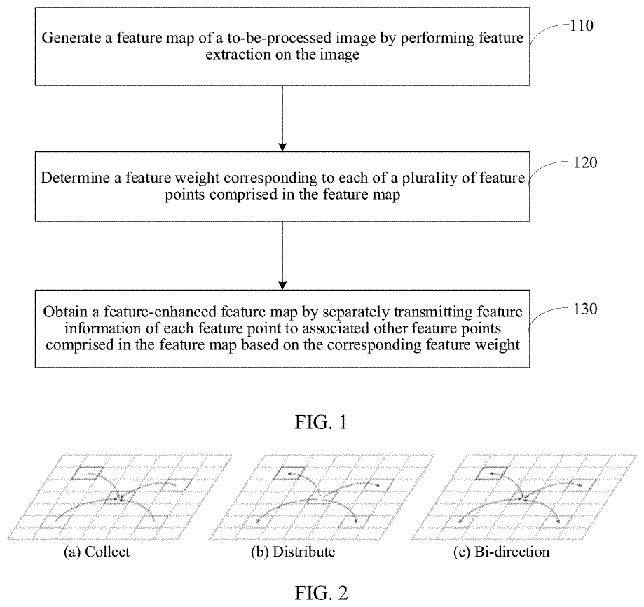

In one or more optional embodiments, FIG. 2 is a schematic diagram of information transmission between feature points in one optional example of an image processing method according to the present application. As shown in (a) Collect of FIG. 2, there is only unidirectional transmission between feature points, to collect information. Taking an intermediate feature point as an example, feature information transmitted by a surrounding feature point to the feature point is received. As shown in (b) Distribute of FIG. 2, there is only unidirectional transmission between feature points, to distribute information. Taking an intermediate feature point as an example, feature information of the feature point is transmitted to a surrounding feature point. As shown in (c) Bi-direction of FIG. 2, bi-direction transmission is performed. That is, each feature point not only transmits information outward but also receives information transmitted by a surrounding feature point, to implement bi-direction transmission of information. In this case, feature weights include inward reception weights and outward transmission weights. While a product of the outward transmission weight for sending information outward and the feature information is sent to a surrounding feature point, a product of the inward reception weight and feature information of the surrounding feature point is received and transmitted to the feature point.

In one optional example, step S120 may be performed by a processor by invoking a corresponding instruction stored in a memory, or may be performed by a weight determination unit 72 (as shown in FIG. 7) run by the processor.

At step 130, feature information of each feature point is separately transmitted to associated other feature points included in the feature map based on the corresponding feature weight, to obtain a feature-enhanced feature map.

For a feature point, the associated other feature points are feature points in the feature map associated with the feature point and except the feature point itself.

Each feature point has its own information transmission, which is represented by a point-wise spatial attention mechanism (feature weight). The information transmission can be learned by using a neural network and has relatively strong adaptive abilities. In addition, during learning of information transmission between different feature points, a relative location relationship between feature points is considered.

In one optional example, step S130 may be performed by a processor by invoking a corresponding instruction stored in a memory, or may be performed by a feature enhancement unit 73 (as shown in FIG. 7) run by the processor.

Based on the image processing method provided according to the foregoing embodiments of the present application, feature extraction is performed on a to-be-processed image to generate a feature map of the image, a feature weight corresponding to each of multiple feature points included in the feature map is determined, and feature information of each feature point is transmitted to associated other feature points comprised in the feature map based on the corresponding feature weight, to obtain a feature-enhanced feature map. Information is transmitted between feature points, so that context information can be better used, and the feature-enhanced feature map includes more information.

In one or more optional embodiments, the method in the embodiments may further include: performing scene analysis processing or object segmentation processing on the image based on the feature-enhanced feature map.

In the embodiments, each feature point in the feature map can not only collect information about other points to help the prediction of the current point, but also distribute information about the current point to help the prediction of other points. A Point-wise Spatial Attention (PSA) solution in this solution design is adaptive learning adjustment and is related to a location relationship. Based on the feature-enhanced feature map, context information of a complex scene can be better used to help the processing such as scene parsing or object segmentation.

In one or more optional embodiments, the method in the embodiments may further include: performing robot navigation control or vehicle intelligent driving control based on a result of the scene analysis processing or a result of the object segmentation processing.

If scene analysis processing or object segmentation processing is performed by using context information of a complex scene, an obtained result of the scene analysis processing or an obtained result of the object segmentation processing is more accurate, and is approximate to a human-eye processing result. If this method is applied to robot navigation control or vehicle intelligent driving control, a result approximate to manual control is achieved.

In one or more optional embodiments, feature weights of the feature points included in the feature map include inward reception weights and outward transmission weights.

The inward reception weight indicates a weight used by a feature point to receive feature information of another feature point included in the feature map. The outward transmission weight indicates a weight used by a feature point to send feature information to another feature point included in the feature map.

In the embodiments of the present application, bi-direction transmission of information between feature points is implemented by means of the inward reception weight and the outward transmission weight, so that each feature point in the feature map can not only collect information about other feature points to help the prediction of the current feature point, but also distribute information about the current feature point to help the prediction of other feature points. Bi-direction transmission of information improves the prediction accuracy.

Optionally, step 120 may include:

performing first branch processing on the feature map to obtain a first weight vector with respect to the inward reception weights of each of the included multiple feature points; and

performing second branch processing on the feature map to obtain a second weight vector with respect to the outward transmission weights of each of the included multiple feature points.

The feature map includes multiple feature points, and each feature point corresponds to at least one inward reception weight and at least one outward transmission weight. Therefore, in the embodiments of the present application, the feature map is processed by using two branches separately, to obtain a first weight vector with respect to the inward reception weights of each of the multiple feature points included in the feature map, and a second weight vector with respect to the outward transmission weights of at least one of the multiple feature points. By separately obtaining the two weight vectors, the efficiency of bi-direction transmission of information between feature points is improved, to implement faster information transmission.

In one or more optional embodiments, the performing first branch processing on the feature map to obtain a first weight vector with respect to the inward reception weights of each of the included multiple feature points includes:

performing, by the neural network, processing on the feature map to obtain a first intermediate weight vector; and

removing invalid information in the first intermediate weight vector to obtain the first weight vector.

The invalid information indicates information in the first intermediate weight vector that has no impact on feature transmission or has an impact degree, for the feature transmission, less than a specified condition.

In the embodiments of the present application, to obtain comprehensive weight information corresponding to each feature point, it is necessary to obtain weights used by the surrounding locations of the feature point to transmit information to the feature point. However, since the feature map includes feature points of some edges, only some surrounding locations of these feature points have feature points. Therefore, the first intermediate weight vector obtained by means of the processing of the neural network includes much meaningless invalid information. The invalid information has only one transmit end (feature point), and therefore, whether to transmit the information has no impact on feature transmission or has an impact degree less than a specified condition. The first weight vector can be obtained after the invalid information is removed. The first weight vector does not include useless information while ensuring that information is comprehensive, thereby improving the efficiency of transmitting useful information.

Optionally, the performing, by the neural network, processing on the feature map to obtain a first intermediate weight vector includes:

using each feature point in the feature map as a first input point, and using a surrounding location of the first input point as a first output point corresponding to the first input point;

obtaining a first transmission ratio vector between the first input point and the first output point corresponding to the first input point in the feature map; and

obtaining the first intermediate weight vector based on the first transmission ratio vector.

In the embodiments, each feature point in the feature map is used as an input point, and in order to obtain a more comprehensive feature information transmission path, surrounding locations of the input point are used as output points. The surrounding locations include multiple feature points in the feature map and multiple adjacent locations of the first input point in a spatial position. Optionally, all surrounding locations of the first input point may be used as first output points corresponding to the first input point. The multiple feature points may be all or some feature points in the feature map, e.g., including all feature points in the feature map and eight adjacent locations of the spatial location of the input point. The eight adjacent locations are determined based on a 3×3 cube that uses the input point as a center. The feature point overlaps the eight adjacent locations, and an overlapped location is used as one output point. In this case, all first transmission ratio vectors corresponding to the input point are generated and obtained, and information of the output points is transmitted to the input point in a transmission ratio by using the transmission ratio vectors. In the embodiments, a transmission ratio for transmitting information between two feature points can be obtained.

Optionally, the removing invalid information in the first intermediate weight vector to obtain the first weight vector includes:

identifying, from the first intermediate weight vector, a first transmission ratio vector whose information included in the first output point is null;

removing, from the first intermediate weight vector, the first transmission ratio vector whose information included in the first output point is null, to obtain the inward reception weights of the feature map; and determining the first weight vector based on the inward reception weights.

In the embodiments, at least one feature point (for example, all feature points) is used as a first input point. Therefore, when there is no feature point at a surrounding location of the first input point, a first transmission ratio vector of the location is useless. In other words, zero multiplied by any value is zero, which is the same as no information transmitted. In the embodiments, all inward reception weights are obtained after these useless first transmit vectors are removed, to determine the first weight vector. In the embodiments of the present application, operations of learning a large intermediate weight vector first and then performing selective selection are used, to take relative location information of feature information into consideration.

Optionally, the determining the first weight vector based on the inward reception weights includes:

arranging the inward reception weights based on corresponding locations of the first output point, to obtain the first weight vector.

To match an inward reception weight with a location of a feature point corresponding to the inward reception weight, in the embodiments, inward reception weights obtained for feature points are arranged based on locations of first output points corresponding to the feature point, thereby facilitating subsequent information transmission. Multiple first output points corresponding to one feature point are sorted based on inward reception weights. Optionally, in a subsequent information transmission process, information transmitted to the feature point by multiple output points may be received in sequence.

Optionally, before the performing, by a neural network, processing on the feature map to obtain a first intermediate weight vector, the method further includes:

performing, by a convolutional layer, dimension reduction processing on the feature map, to obtain a first intermediate feature map.

The performing, by a neural network, processing on the feature map to obtain a first intermediate weight vector includes:

processing, by the neural network, the dimension-reduced first intermediate feature map, to obtain the first intermediate weight vector.

To improve a processing speed, before the feature map is processed, dimension reduction processing is further performed on the feature map, to reduce a calculation amount by reducing the number of channels.

Optionally, the processing, by the neural network, the dimension-reduced first intermediate feature map, to obtain the first intermediate weight vector includes:

using each feature point in the first intermediate feature map as a first input point, and using all surrounding locations of the first input point as first output points corresponding to the first input point;

obtaining first transmission ratio vectors between the first input point and all the first output points corresponding to the first input point in the first intermediate feature map; and

obtaining the first intermediate weight vector based on the first transmission ratio vectors.

In the embodiments, each first intermediate feature point in the dimension-reduced first intermediate feature map is used as an input point, and all surrounding locations of the input point are used as output points. All the surrounding locations include multiple feature points in the first intermediate feature map and multiple adjacent locations of the first input point in a spatial position. The multiple feature points are all or some first intermediate feature points in the first intermediate feature map, for example, include all first intermediate feature points in the first intermediate feature map and eight adjacent locations of the spatial location of the input point. The eight adjacent locations are determined based on a 3×3 cube that uses the input point as a center. The feature point overlaps the eight adjacent locations, and an overlapped location is used as one output point. In this case, all first transmission ratio vectors corresponding to the input point are generated and obtained, and information of the output points is transmitted to the input point in a transmission ratio by using the transmission ratio vectors. In the embodiments, a transmission ratio for transmitting information between two first intermediate feature points can be obtained.

In one or more optional embodiments, the performing second branch processing on the feature map to obtain a second weight vector with respect to outward transmission weights of each of the included multiple feature points includes:

performing, by a neural network, processing on the feature map to obtain a second intermediate weight vector; and

removing invalid information in the second intermediate weight vector to obtain the second weight vector.

The invalid information indicates information in the second intermediate weight vector that has no impact on feature transmission or has an impact degree, for the feature transmission, less than a specified condition.

In the embodiments of the present application, in order to obtain comprehensive weight information corresponding to each feature point in the feature map, it is necessary to obtain weights used by the feature point to transmit information to surrounding locations. However, since the feature map includes feature points of some edges, only some surrounding locations of these feature points have feature points. Therefore, the second intermediate weight vector obtained by means of the processing of the neural network includes much meaningless invalid information. The invalid information has only one transmit end (feature point), and therefore, whether to transmit the information has no impact on feature transmission or has an impact degree less than a specified condition. The second weight vector can be obtained after the invalid information is removed. The second weight vector does not include useless information while ensuring that information is comprehensive, thereby improving the information transmission efficiency.

Optionally, the performing, by the neural network, processing on the feature map to obtain a second intermediate weight vector includes:

using each feature point in the feature map as a second output point, and using a surrounding location of the second output point as a second input point corresponding to the second output point;

obtaining a second transmission ratio vector between the second output point and the second input point corresponding to the second output point in the feature map; and

obtaining the second intermediate weight vector based on the second transmission ratio vector.

In the embodiments, each feature point in the feature map is used as an output point, and in order to obtain a more comprehensive feature information transmission path, surrounding locations of the output point are used as input points. The surrounding locations include multiple feature points in the feature map and multiple adjacent locations of the second output point in a spatial position. Optionally, all surrounding locations of the second output point may be used as second input points corresponding to the second output point. The multiple feature points may be all or some feature points in the feature map, e.g., including all feature points in the feature map and eight adjacent locations of the spatial location of the output point. The eight adjacent locations are determined based on a 3×3 cube that uses the output point as a center. The feature point overlaps the eight adjacent locations, and an overlapped location is used as one input point. In this case, all second transmission ratio vectors corresponding to the second output point are generated and obtained, and information of the input points is transmitted to the output point in a transmission ratio by using the transmission ratio vectors. In the embodiments, a transmission ratio for transmitting information between two feature points can be obtained.

Optionally, the removing invalid information in the second intermediate weight vector to obtain the second weight vector includes:

identifying, from the second intermediate weight vector, a second transmission ratio vector whose information included in the second output point is null;

removing, from the second intermediate weight vector, the second transmission ratio vector whose information included in the second output point is null, to obtain the outward transmission weights of the feature map; and determining the second weight vector based on the outward transmission weights.

In the embodiments, at least one feature point (for example, all feature points) is used as a second output point. Therefore, when there is no feature point at a surrounding location of the second output point, a second transmission ratio vector of the location is useless. That is, zero multiplied by any value is zero, which is the same as no information transmitted. In the embodiments, outward transmission weights are obtained after these useless second transmission ratio vectors are removed, to determine the second weight vector. In the embodiments of the present application, operations of learning a large intermediate weight vector and then performing selective selection are used, to take relative location information of feature information into consideration.

Optionally, the determining the second weight vector based on the outward transmission weights includes:

arranging the outward transmission weights based on the location of the corresponding second input point, to obtain the second weight vector.

To match an outward transmission weight with a location of a feature point corresponding thereto, in the embodiments, outward transmission weights obtained for feature points are arranged based on locations of second input points corresponding to the feature point, thereby facilitating subsequent information transmission. Multiple second input points corresponding to one feature point are sorted based on outward transmission weights. Optionally, in the subsequent information transmission process, information of the feature point may be transmitted to multiple input points in sequence.

Optionally, before the performing, by a neural network, processing on the feature map to obtain a second intermediate weight vector, the method further includes:

performing, by a convolutional layer, dimension reduction processing on the feature map, to obtain a second intermediate feature map.

The performing, by a neural network, processing on the feature map to obtain a second intermediate weight vector includes:

processing, by the neural network, the dimension-reduced first intermediate feature map, to obtain the second intermediate weight vector.

To improve a processing speed, before the feature map is processed, dimension reduction processing is further performed on the feature map, to reduce a calculation amount by reducing the number of channels. Dimension reduction is performed on a same feature map by using a same neural network. Optionally, the first intermediate feature map and the second intermediate feature map obtained after the feature map is subjected to dimension reduction may be the same or different.

Optionally, the processing by the neural network, the dimension-reduced second intermediate feature map, to obtain the second intermediate weight vector includes:

using each feature point in the second intermediate feature map as a second output point, and using second intermediate feature points at all surrounding locations of the second output point as second input points corresponding to the second output point;

obtaining second transmission ratio vectors between the second output point and all the second input points corresponding to the second output point in the second intermediate feature map; and

obtaining the second intermediate weight vector based on the second transmission ratio vectors.

In the embodiments, each second intermediate feature point in the dimension-reduced second intermediate feature map is used as an output point. All surrounding locations include multiple second intermediate feature points in the second intermediate feature map and multiple adjacent locations of the second output point in a spatial position. All surrounding locations of the output point are used as input points. In this case, all second transmission ratio vectors corresponding to the output point are generated and obtained, and information of the output points is transmitted to the input point in a transmission ratio by using the transmission ratio vectors. In the embodiments, a transmission ratio for transmitting information between two second intermediate feature points can be obtained.

In one or more optional embodiments, step 130 may include:

obtaining a first feature vector based on the first weight vector and the feature map, and obtaining a second feature vector based on the second weight vector and the feature map; and

obtaining the feature-enhanced feature map based on the first feature vector, the second feature vector, and the feature map.

In the embodiments, feature information received by a feature point in the feature map is obtained by using the first weight vector and the feature map, and feature information transmitted by a feature point in the feature map is obtained by using the second weight vector and the feature map. That is, feature information of bi-direction transmission is obtained. The enhanced feature map including more information can be obtained based on the feature information of bi-direction transmission and the feature map.

Optionally, the obtaining a first feature vector based on the first weight vector and the feature map, and obtaining a second feature vector based on the second weight vector and the feature map includes:

performing matrix multiplication processing on the first weight vector and the first intermediate feature map, to obtain the first feature vector, where the first intermediate feature map is obtained by performing dimension reduction processing on the feature map; and

performing matrix multiplication processing on the second weight vector and the second intermediate feature map, to obtain the second feature vector, where the second intermediate feature map is obtained by performing dimension reduction processing on the feature map; or

performing matrix multiplication processing on the first weight vector and the feature map, to obtain the first feature vector; and

performing matrix multiplication processing on the second weight vector and the feature map, to obtain the second feature vector.

In the embodiments, invalid information is removed, and the obtained first weight vector and the dimension-reduced first intermediate feature map meet a requirement of matrix multiplication. In this case, each feature point in the first intermediate feature map is multiplied by a weight corresponding to the feature point by means of matrix multiplication, so that feature information is transmitted to at least one feature point (for example, each feature point) based on the weight. The second feature vector is used to transmit feature information outward from at least one feature point (for example, each feature point) based on a corresponding weight.

When the matrix multiplication processing is performed on the weight vectors and the feature map, the first weight vector and the second weight vector as well as the feature map are required to meet the requirements of matrix multiplication. Optionally, each feature point in the feature map is multiplied by a weight corresponding to the feature point by means of matrix multiplication, so that feature information is transmitted to each feature point based on the weight. The second feature vector is used to transmit feature information outward from each feature point based on a corresponding weight.

Optionally, the obtaining the feature-enhanced feature map based on the first feature vector, the second feature vector, and the feature map includes:

splicing the first feature vector and the second feature vector in a channel dimension to obtain a spliced feature vector; and

splicing the spliced feature vector and the feature map in the channel dimension to obtain the feature-enhanced feature map.

The first feature vector and the second feature vector are combined by splicing, to obtain bi-directionally transmitted information, and then the bi-directionally transmitted information is spliced with the feature map, to obtain the feature-enhanced feature map. The feature-enhanced feature map includes not only feature information of each feature point in the original feature map, but also feature information bi-directionally transmitted between every two feature points.

Optionally, before the splicing the spliced feature vector and the feature map in the channel dimension to obtain the feature-enhanced feature map, the method further includes:

performing feature projection processing on the spliced feature vector to obtain a processed spliced feature vector.

The splicing the spliced feature vector and the feature map in the channel dimension to obtain the feature-enhanced feature map includes:

splicing the processed spliced feature vector and the feature map in the channel dimension to obtain the feature-enhanced feature map.

Optionally, one neural network is used for processing (for example, cascading of one convolutional layer and a non-linear activation layer) to implement feature projection. The spliced feature vector and the feature map are unified in other dimensions than the channel by means of feature projection, so that splicing in the channel dimension can be implemented.

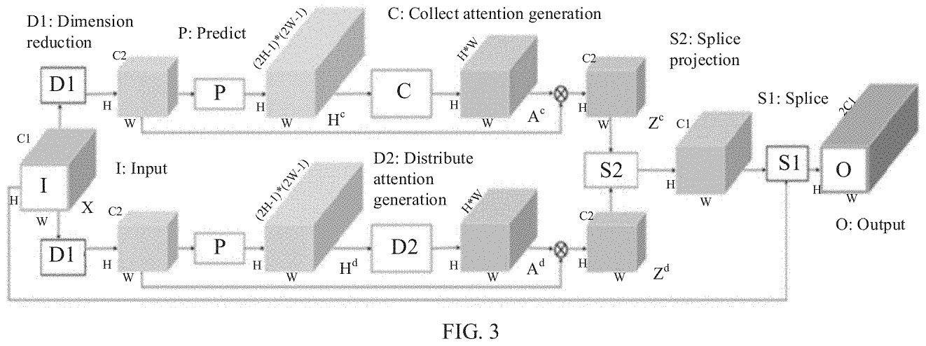

FIG. 3 is a schematic diagram of a network structure of another embodiment of an image processing method according to the present application. As shown in FIG. 3, for an input image feature, the processing process is divided into two branches. One is an information collect flow responsible for information collection, and the other is an information distribute flow responsible for information distribution. 1) In each branch, a convolution operation for reducing the number of channels is first performed, and the calculation amount is reduced by means of feature reduction.

2) A feature weight of the dimension-reduced feature map is predicted (adaption) by using a small neural network (which is usually obtained by cascading some convolutional layers and non-linear activation layers, and these are basic modules of a convolutional neural network), and feature weights that are approximately twice the size of the feature map are obtained (for example, if the size of the feature map is H×W (the height is H and the width is W), the number of feature weights obtained by performing prediction on each feature point is (2H−1)×(2W−1), so as to ensure that information can be transmitted between each point and all points in the entire map while a relative location relationship is considered).

3) Tight and valid weights that are in the same size as the input feature are obtained by collecting or distributing feature weights (only H*W weights in the (2H−1)×(2W−1) weights obtained by performing prediction on each point are valid, and the others are invalid), and valid weights are extracted and rearranged, to obtain a compact weight matrix.

4) Matrix multiplication is performed on the obtained weight matrix and the dimension-reduced feature, to perform information transmission.

5) Features obtained from the two branches are first spliced, and then are subjected to feature projection (, for example, one neural network is used to process the obtained features (for example, cascading of one convolutional layer and one non-linear activation layer)) processing, to obtain a global feature.

6) The obtained global feature and the initial input feature are spliced to obtain a final output feature expression. The splicing means splicing in a feature dimension. Certainly, the original input feature and the new global feature are fused here, and splicing is only a relatively simple manner. Adding or other fusion manners can also be used. The feature includes both semantic information in the original feature and global context information corresponding to the global feature.

The obtained feature-enhanced feature can be used for scene parsing. For example, the feature-enhanced feature is directly input to a classifier implemented by one small convolutional neural network, to classify each point.

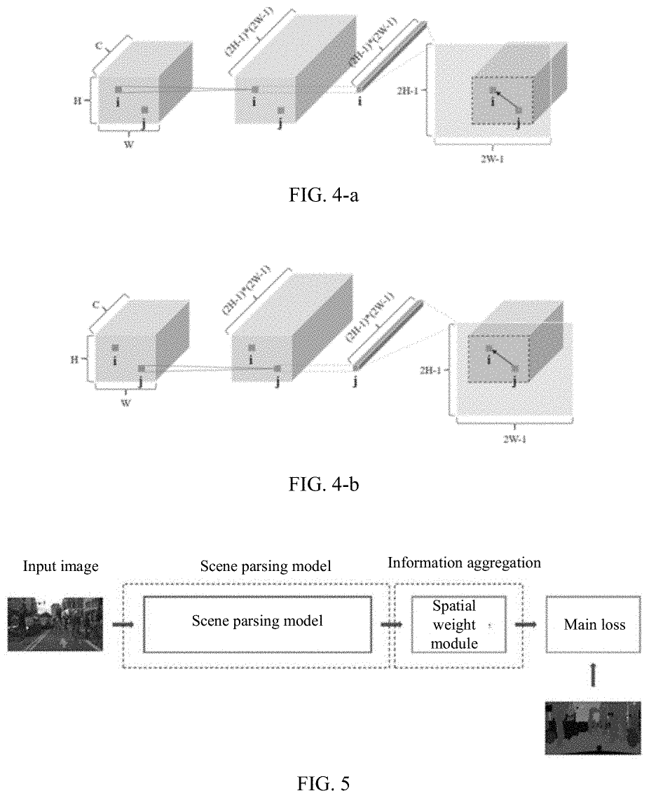

FIG. 4-a is a schematic diagram of obtaining a weight vector of an information collect branch in another embodiment of an image processing method according to the present application. As shown in FIG. 4-a, for a generated large feature weight, in the information collect branch, a center point with which non-compact weight features are aligned is a target feature point i, and (2H−1)×(2W−1) non-compact feature weights predicted on each feature point can be expanded into one semi-transparent rectangle covering the entire map, and a center of the rectangle is aligned with the point. This step ensures that a relative location relationship between feature points is accurately considered when predicting feature weights. FIG. 4-b is a schematic diagram of obtaining a weight vector of an information distribute branch in another embodiment of an image processing method according to the present application. As shown in FIG. 4-b, for the information distribute branch, an aligned center point is an information departure point j. (2H−1)×(2W−1) non-compact feature weights predicted on each feature point can be expanded into one semi-transparent rectangle covering the entire map, and the semi-transparent rectangle is a mask. An overlapping area is shown by a dashed line box, and is a valid weight feature.

In one or more optional embodiments, the method in the embodiments is implemented by using a feature extraction network and a feature enhancement network.

The method in the embodiments further includes:

training the feature enhancement network by using a sample image, or training the feature extraction network and the feature enhancement network by using a sample image.

The sample image has an annotation processing result which includes an annotated scene analysis result or an annotated object segmentation result.

To better implement the processing of the image tasks, it is necessary to train a network before network prediction. The feature extraction network involved in the embodiments can be pre-trained or untrained. When the feature extraction network is pre-trained, only the feature enhancement network is trained, or both the feature extraction network and the feature enhancement network are trained. When the feature extraction network is untrained, the feature extraction network and the feature enhancement network are trained by using the sample image.

Optionally, the training the feature enhancement network by using a sample image includes:

inputting the sample image into the feature extraction network and the feature enhancement network to obtain a prediction processing result; and

training the feature enhancement network based on the prediction processing result and the annotation processing result.

In this case, after the feature enhancement network is connected to the trained feature extraction network, the feature enhancement network is trained based on the obtained prediction processing result. For example, a proposed PSA module (corresponding to the feature enhancement network provided in the foregoing embodiments) is embedded into a scene parsing framework. FIG. 5 is an exemplary schematic structural diagram of network training in an image processing method according to the present application. As shown in FIG. 5, an input image passes through an existing scene parsing model, an output feature map is transmitted to a PSA module structure for information aggregation, to obtain a final feature input classifier for scene parsing, and a main loss is obtained based on a predicted scene parsing result and an annotation processing result. The main loss corresponds to the first loss in the foregoing embodiments, and the feature enhancement network is trained based on the main loss.

Optionally, the training the feature extraction network and the feature enhancement network by using a sample image includes:

inputting the sample image into the feature extraction network and the feature enhancement network to obtain a prediction processing result;

obtaining a first loss based on the prediction processing result and the annotation processing result; and

training the feature extraction network and the feature enhancement network based on a first loss.

Since the feature extraction network and the feature enhancement network are connected in sequence, when the obtained first loss (for example, the main loss) is fed back to the feature enhancement network, the first loss is fed back forward, so that the feature extraction network can be trained or fine-tuned (if the feature extraction network is pre-trained, the feature extraction network can only be fine-tuned). Therefore, both the feature extraction network and the feature enhancement network are trained, thereby ensuring that a result of a scene analysis task or an object segmentation task is more accurate.

Optionally, the method in the embodiments may further include:

determining an intermediate prediction processing result based on a feature map output by an intermediate layer in the feature extraction network;

obtaining a second loss based on the intermediate prediction processing result and the annotation processing result; and

adjusting parameters of the feature extraction network based on the second loss.

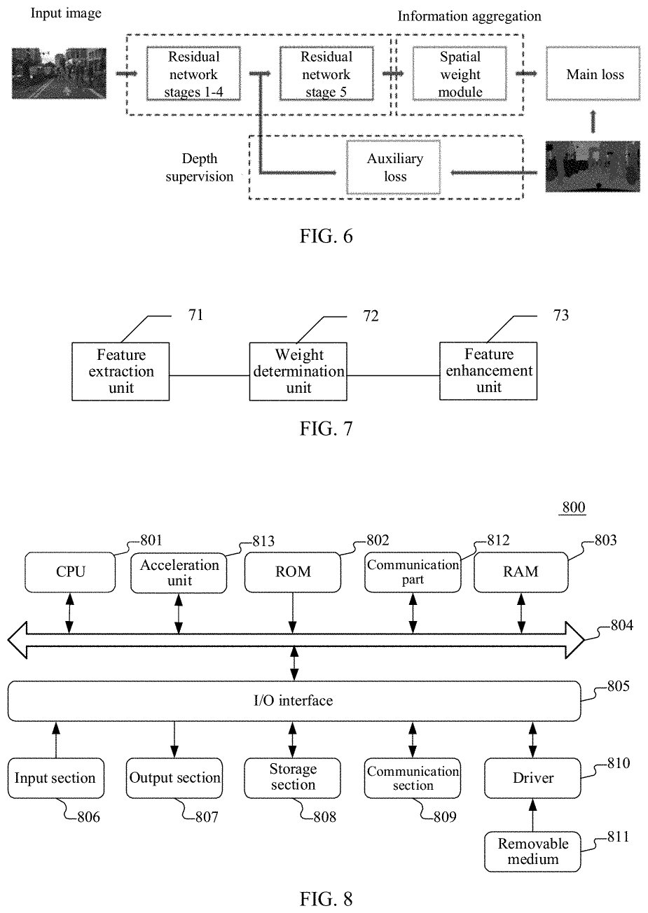

When the feature extraction network is untrained, in the process of training the feature extraction network, the second loss (for example, an auxiliary loss) is further added. The proposed PSA module (corresponding to the feature enhancement network provided in the foregoing embodiments) is embedded into a scene parsing framework. FIG. 6 is another exemplary schematic structural diagram of network training in an image processing method according to the present application. As shown in FIG. 6, the PSA module functions on a final feature representation (such as Stage 5) of a fully-connected network based on a residual network (ResNet), so that information is integrated better, and context information of a scene is better used. Optionally, the residual network includes five stages. After the input image passes through four stages, the processing process is divided into two branches. In a primary branch, a feature map is obtained after the fifth stage, then a PSA structure is input, a final feature map input classifier classifies each point, and a main loss is obtained to train the residual network and the feature enhancement network. The main loss corresponds to the first loss in the foregoing embodiments. In a side branch, the output at the fourth stage is directly input to the classifier for scene parsing. The side branch is mainly used in a neural network training process to assist and supervise training based on an obtained auxiliary loss. The auxiliary loss corresponds to the second loss in the foregoing embodiments, and during a test, a scene analysis result in the primary branch is mainly used.

Persons of ordinary skill in the art may understand that all or some steps for implementing the foregoing method embodiments are achieved by a program by instructing relevant hardware. The foregoing program may be stored in a non-volatile computer readable storage medium. When the program is executed, steps including the foregoing method embodiments are performed. Moreover, the foregoing storage medium includes any medium that can store program codes, such as a Read-Only Memory (ROM), a magnetic disk, or an optical disk.

FIG. 7 is a schematic structural diagram of an embodiment of an image processing apparatus according to the present application. The apparatus in the embodiments is configured to implement the foregoing method embodiments of the present application. As shown in FIG. 7, the apparatus in the embodiments includes a feature extraction unit 71, a weight determination unit 72, and a feature enhancement unit 73.

The feature extraction unit 71 is configured to perform feature extraction on a to-be-processed image to generate a feature map of the image.

The image in the embodiments is an image that has not undergone feature extraction processing, or is a feature map or the like that is obtained after feature extraction is performed for one or more times. A specific form of the to-be-processed image is not limited in the present application.

The weight determination unit 72 is configured to determine a feature weight corresponding to each of a plurality of feature points included in the feature map.

The multiple feature points in the embodiments are all feature points or some feature points in the feature map. To transmit information between feature points, it is necessary to determine a transmission probability. That is, all or a part of information of one feature point is transmitted to another feature point, and a transmission ratio is determined by a feature weight.

The feature enhancement unit 73 is configured to separately transmit feature information of each feature point to associated other feature points included in the feature map based on the corresponding feature weight, to obtain a feature-enhanced feature map.

For a feature point, the associated other feature points are feature points in the feature map associated with the feature point and except the feature point itself.

Based on the image processing apparatus provided according to the foregoing embodiments of the present application, feature extraction is performed on a to-be-processed image to generate a feature map of the image, a feature weight corresponding to each of multiple feature points included in the feature map is determined, and feature information of the feature point corresponding to the feature weight is separately transmitted to multiple other feature points included in the feature map, to obtain a feature-enhanced feature map. Information is transmitted between feature points, so that context information can be better used, and the feature-enhanced feature map includes more information.

In one or more optional embodiments, the apparatus further includes:

an image processing unit, configured to perform scene analysis processing or object segmentation processing on the image based on the feature-enhanced feature map.

In the embodiments, each feature point in the feature map can not only collect information about other points to help the prediction of the current point, but also distribute information about the current point to help the prediction of other points. A PSA solution in this solution design is adaptive learning adjustment and is related to a location relationship. Based on the feature-enhanced feature map, context information of a complex scene can be better used to help the processing such as scene parsing or object segmentation.

Optionally, the apparatus in the embodiments further includes:

a result application unit, configured to perform robot navigation control or vehicle intelligent driving control based on a result of the scene analysis processing or a result of the object segmentation processing.

In one or more optional embodiments, feature weights of the feature points included in the feature map include inward reception weights and outward transmission weights. The inward reception weight indicates a weight used by a feature point to receive feature information of another feature point included in the feature map. The outward transmission weight indicates a weight used by a feature point to send feature information to another feature point included in the feature map.

Bi-direction transmission of information between feature points is implemented by the inward reception weight and the outward transmission weight, so that each feature point in the feature map can not only collect information about other feature points to help the prediction of the current feature point, but also distribute information about the current feature point to help the prediction of other feature points.

Optionally, the weight determination unit 72 includes:

a first weight module, configured to perform first branch processing on the feature map to obtain a first weight vector with respect to the inward reception weights of each of the included multiple feature points; and

a second weight module, configured to perform second branch processing on the feature map to obtain a second weight vector with respect to the outward transmission weights of each of the included multiple feature points.

In one or more optional embodiments, the first weight module includes:

a first intermediate vector module, configured to perform processing on the feature map by using a neural network, to obtain a first intermediate weight vector; and

a first information removing module, configured to remove invalid information in the first intermediate weight vector to obtain a first weight vector.

The invalid information indicates information in the first intermediate weight vector that has no impact on feature transmission or has an impact degree, for the feature transmission, less than a specified condition.

In the embodiments, to obtain comprehensive weight information corresponding to each feature point in the feature, it is necessary to obtain weights used by feature points at surrounding locations of the feature point to transmit information to the feature point. However, since the feature map includes feature points of some edges, only some surrounding locations of these feature points have feature points. Therefore, the first intermediate weight vector obtained by means of the processing of the neural network includes much meaningless invalid information. The invalid information has only one transmit end (feature point), and therefore, whether to transmit the information has no impact on feature transmission or has an impact degree less than a specified condition. The first weight vector can be obtained after the invalid information is removed. The first weight vector does not include useless information while ensuring that information is comprehensive, thereby improving the information transmission efficiency.

Optionally, the first intermediate vector module is configured to use each feature point in the feature map as a first input point, and use a surrounding location of the first input point as a first output point corresponding to the first input point, where the surrounding location includes multiple feature points in the feature map and multiple adjacent locations of the first input point in a spatial position; obtain a first transmission ratio vector between the first input point and the first output point corresponding to the first input point in the feature map; and obtain the first intermediate weight vector based on the first transmission ratio vectors.

Optionally, the first information removing module is configured to identity, from the first intermediate weight vector, a first transmission ratio vector whose information included in the first output point is null; remove, from the first intermediate weight vector, the first transmission ratio vector whose information included in the first output point is null, to obtain the inward reception weights of the feature map; and determine the first weight vector based on the inward reception weights.

Optionally, when determining the first weight vector based on the inward reception weights, the first information removing module is configured to arrange the inward reception weights based on locations of corresponding first output points, to obtain the first weight vector.

Optionally, the first weight module further includes:

a first dimension reduction module, configured to perform dimension reduction processing on the feature map by using a convolutional layer, to obtain a first intermediate feature map.

The first intermediate vector module is configured to perform processing on the dimension-reduced first intermediate feature map by using the neural network, to obtain the first intermediate weight vector.

In one or more optional embodiments, the second weight module includes:

a second intermediate vector module, configured to perform processing on the feature map by using a neural network, to obtain a second intermediate weight vector; and

a second information removing module, configured to remove invalid information in the second intermediate weight vector to obtain a second weight vector.

The invalid information indicates information in the second intermediate weight vector that has no impact on feature transmission or has an impact degree, for the feature transmission, less than a specified condition.

In the embodiments, to obtain comprehensive weight information corresponding to each feature point, it is necessary to obtain weights used by surrounding locations to transmit information. However, since the feature map includes feature points of some edges, only some surrounding locations of these feature points have feature points. Therefore, the second intermediate weight vector obtained by means of the processing of the neural network includes much meaningless invalid information. The invalid information has only one transmit end (feature point), and therefore, whether to transmit the information has no impact on feature transmission or has an impact degree less than a specified condition. The second weight vector can be obtained after the invalid information is removed. The second weight vector does not include useless information while ensuring that information is comprehensive, thereby improving efficiency of transmitting useful information.

Optionally, the second intermediate vector module is configured to use each feature point in the feature map as a second output point, and use a surrounding location of the second output point as a second input point corresponding to the second output point, where the surrounding location includes multiple feature points in the feature map and multiple adjacent locations of the second output point in a spatial position; obtain a second transmission ratio vector between the second output point and the second input point corresponding to the second output point in the feature map; and obtain the second intermediate weight vector based on the second transmission ratio vector.

Optionally, the second information removing module is configured to identity, from the second intermediate weight vector, the second transmission ratio vector whose information included in the second output point is null; remove, from the second intermediate weight vector, the second transmission ratio vector whose information included in the second output point is null, to obtain the outward transmission weights of the feature map; and determine the second weight vector based on the outward transmission weights.

Optionally, when determining the second weight vector based on the outward transmission weights, the second information removing module is configured to arrange the outward transmission weights based on locations of corresponding second input points to obtain the second weight vector.

Optionally, the second weight module further includes:

a second dimension reduction module, configured to perform dimension reduction processing on the feature map by using a convolutional layer, to obtain a second intermediate feature map.

The second intermediate vector module is configured to perform processing on the dimension-reduced second intermediate feature map by using the neural network, to obtain the second intermediate weight vector.

In one or more optional embodiments, the feature enhancement unit includes:

a feature vector module, configured to obtain a first feature vector based on the first weight vector and the feature map, and obtain a second feature vector based on the second weight vector and the feature map; and

an enhanced feature map module, configured to obtain the feature-enhanced feature map based on the first feature vector, the second feature vector, and the feature map.

In the embodiments, feature information received by a feature point in the feature map is obtained by using the first weight vector and the feature map, and feature information transmitted by a feature point in the feature map is obtained by using the second weight vector and the feature map. That is, feature information of bi-direction transmission is obtained. The enhanced feature map including more information can be obtained based on the feature information of bi-direction transmission and the original feature map.

Optionally, the feature vector module is configured to perform matrix multiplication processing on the first weight vector and the feature map or the first intermediate feature map obtained after the feature map is subjected to dimension reduction processing, to obtain the first feature vector; and perform matrix multiplication processing on the second weight vector and the feature map or the second intermediate feature map obtained after the feature map is subjected to dimension reduction processing, to obtain the second feature vector.

Optionally, the enhanced feature map module is configured to splice the first feature vector and the second feature vector in the channel dimension to obtain a spliced feature vector; and splice the spliced feature vector and the feature map in the channel dimension to obtain the feature-enhanced feature map.

Optionally, the feature enhancement unit further includes:

a feature projection module, configured to perform feature projection processing on the spliced feature vector to obtain a processed spliced feature vector.

The enhanced feature map module is configured to splice the processed spliced feature vector and the feature map in the channel dimension to obtain the feature-enhanced feature map.

In one or more optional embodiments, the apparatus in the embodiments is implemented by using a feature extraction network and a feature enhancement network.

The apparatus in the embodiments further includes:

a training unit, configured to train the feature enhancement network by using a sample image, or train the feature extraction network and the feature enhancement network by using a sample image.

The sample image has an annotation processing result which includes an annotated scene analysis result or an annotated object segmentation result.

To better achieve the processing of the image tasks, it is necessary to train a network before network prediction. The feature extraction network involved in the embodiments can be pre-trained or untrained. When the feature extraction network is pre-trained, only the feature enhancement network is trained, or both the feature extraction network and the feature enhancement network are trained. When the feature extraction network is untrained, the feature extraction network and the feature enhancement network are trained by using the sample image.

Optionally, the input unit is configured to input the sample image into the feature extraction network and the feature enhancement network to obtain a prediction processing result; and train the feature enhancement network based on the prediction processing result and the annotation processing result.

Optionally, the input unit is configured to input the sample image into the feature extraction network and the feature enhancement network to obtain a prediction processing result; obtain a first loss based on the prediction processing result and the annotation processing result; and train the feature extraction network and the feature enhancement network based on the first loss.

Optionally, the training unit is further configured to determine an intermediate prediction processing result based on a feature map that is output by an intermediate layer in the feature extraction network; obtain a second loss based on the intermediate prediction processing result and the annotation processing result; and adjust parameters of the feature extraction network based on the second loss.

For working processes, setting manners, and corresponding technical effects of any embodiment of the image processing apparatus provided in the embodiments of the present application, reference may be made to specific descriptions of the foregoing corresponding method embodiments of the present application. Due to length limitations, details are not described herein again.

An electronic device provided according to another aspect of the embodiments of the present application includes a processor, where the processor includes the image processing apparatus according to any one of the embodiments above. Optionally, the electronic device may be an in-vehicle electronic device.

An electronic device provided according to another aspect of the embodiments of the present application includes: a memory, configured to store executable instructions; and

a processor, configured to communicate with the memory to execute the executable instructions to complete operations of the image processing method according to any one of the embodiments above.

A computer storage medium provided according to another aspect of the embodiments of the present application is configured to store computer readable instructions, where when the instructions are executed by a processor, the processor is caused to perform operations of the image processing method according to any one of the embodiments above.

A computer program product provided according to another aspect of the embodiments of the present application includes a computer readable code, where when the computer readable code runs in a device, a processor in the device executes instructions for implementing the image processing method according to any one of the embodiments above.

Embodiments of the present application further provide an electronic device. For example, the electronic device is a mobile terminal, a Personal Computer (PC), a tablet computer, a server and the like. Referring to FIG. 8 below, a schematic structural diagram of an electronic device 800 suitable for implementing a terminal device or a server according to the embodiments of the present application is shown. As shown in FIG. 8, the electronic device 800 includes one or more processors, a communication part, and the like. The one or more processors are, for example, one or more Central Processing Units (CPUs) 801 and/or one or more dedicated processors. The dedicated processor is used as an acceleration unit 813, including, but not limited to, dedicated processors such as a Graphics Processing Unit (GPU), an FPGA, a DSP, and other ASIC chips. The processor may execute various appropriate actions and processing according to executable instructions stored in an ROM 802 or executable instructions loaded from a storage section 808 to a RAM 803. The communication part 812 may include, but is not limited to, a network card. The network card may include, but is not limited to, an IB (InfiniBand) network card.

The processor is communicated with the ROM 802 and/or the RAM 803 to execute executable instructions, is connected to the communication part 812 by means of a bus 804, and is communicated with other target devices by means of the communication part 812, thereby completing operations corresponding to the methods provided in the embodiments of the present application, e.g., performing feature extraction on a to-be-processed image to generate a feature map of the image; determining a feature weight corresponding to each of multiple feature points included in the feature map; and separately transmitting feature information of the feature point corresponding to the feature weight to multiple other feature points included in the feature map, to obtain a feature-enhanced feature map.

In addition, the RAM 803 may further store various programs and data required for operations of an apparatus. The CPU 801, the ROM 802, and the RAM 803 are connected to each other via the bus 804. In the case that the RAM 803 exists, the ROM 802 is an optional module. The RAM 803 stores executable instructions, or writes executable instructions to the ROM 802 during running. The executable instructions cause the CPU 801 to perform corresponding operations of the foregoing communication method. An Input/Output (I/O) interface 805 is also connected to the bus 804. The communication part 812 is integrated, or is configured to have multiple sub-modules (for example, multiple IB network cards) connected to the bus.

The following components are connected to the I/O interface 805: an input section 806 including a keyboard, a mouse, and the like; an output section 807 including a Cathode-Ray Tube (CRT), a Liquid Crystal Display (LCD), a speaker, and the like; the storage section 808 including a hard disk and the like; and a communication section 809 of a network interface card including an LAN card, a modem, and the like. The communication section 809 performs communication processing via a network such as the Internet. A driver 810 is also connected to the I/O interface 805 according to requirements. A removable medium 811 such as a magnetic disk, an optical disk, a magneto-optical disk, a semiconductor memory or the like is mounted on the driver 810 according to requirements, so that a computer program read from the removable medium is installed on the storage section 808 according to requirements.

It should be noted that the architecture shown in FIG. 8 is merely an optional implementation. During specific practice, the number and types of the components in FIG. 8 are selected, decreased, increased, or replaced according to actual requirements. Different functional components are separated or integrated or the like. For example, the acceleration unit 813 and the CPU 801 are separated, or the acceleration unit 813 is integrated on the CPU 801, and the communication part is separated from or integrated on the CPU 801 or the acceleration unit 813 or the like. These alternative implementations all fall within the scope of protection of the present application.

Particularly, a process described above with reference to a flowchart according to the embodiments of the present application is implemented as a computer software program. For example, the embodiments of the present application include a computer program product, which includes a computer program tangibly contained on a machine-readable medium. The computer program includes a program code for executing the method shown in the flowchart. The program code may include corresponding instructions for correspondingly executing the steps of the methods provided in the embodiments of the present application. For example, feature extraction is performed a to-be-processed image to generate a feature map of the image, a feature weight corresponding to each of multiple feature points included in the feature map is determined, and feature information of the feature point corresponding to the feature weight is separately transmitted to multiple other feature points included in the feature map, to obtain a feature-enhanced feature map. In such embodiments, the computer program is downloaded and installed from the network by means of the communication section 809 and/or is installed from the removable medium 811. The computer program, when being executed by the CPU 801, executes the foregoing functions defined in the methods of the present application.

The methods and apparatuses in the present application may be implemented in many manners. For example, the methods and apparatuses in the present application may be implemented with software, hardware, firmware, or any combination of software, hardware, and firmware. The foregoing specific sequence of steps of the method is merely for description, and unless otherwise stated particularly, is not intended to limit the steps of the method in the present application. In addition, in some embodiments, the present application may also be implemented as programs recorded in a recording medium. These programs include machine-readable instructions for implementing the methods according to the present application. Therefore, the present application further covers the recording medium storing the programs for performing the methods according to the present application.

The descriptions of the present disclosure are provided for the purpose of examples and description, and are not intended to be exhaustive or limit the present disclosure to the disclosed form. Many modifications and changes are obvious to persons of ordinary skills in the art. The embodiments are selected and described to better describe a principle and an actual application of the present disclosure, and to make persons of ordinary skills in the art understand the present disclosure, so as to design various embodiments with various modifications applicable to particular use.

1. An image processing method, comprising:
generating a feature map of a to-be-processed image by performing feature extraction on the image;
determining a feature weight corresponding to each of a plurality of feature points comprised in the feature map; and
obtaining a feature-enhanced feature map by separately transmitting feature information of each feature point to associated other feature points comprised in the feature map based on the corresponding feature weight.

2. The method according to claim 1, further comprising:
performing scene analysis processing or object segmentation processing on the image based on the feature-enhanced feature map; and/or
performing robot navigation control or vehicle intelligent driving control based on a result of the scene analysis processing or a result of the object segmentation processing.

3. The method according to claim 1, wherein
the feature weight of the feature point comprised in the feature map comprises an inward reception weight and an outward transmission weight;
the inward reception weight indicates a weight used by a feature point to receive the feature information of another feature point comprised in the feature map, and
the outward transmission weight indicates a weight used by a feature point to send the feature information to another feature point comprised in the feature map.

4. The method according to claim 3, wherein determining the feature weight corresponding to each of the plurality of the feature points comprised in the feature map comprises:
obtaining a first weight vector with respect to inward reception weights of each of the plurality of the feature points by performing first branch processing on the feature map; and
obtaining a second weight vector with respect to outward transmission weights of each of the plurality of feature points by performing second branch processing on the feature map.

5. The method according to claim 4, wherein obtaining the first weight vector with respect to the inward reception weights of each of the plurality of the feature points by performing the first branch processing on the feature map comprises:
obtaining a first intermediate weight vector by processing the feature map through a neural network; and
obtaining the first weight vector by removing invalid information in the first intermediate weight vector, wherein the invalid information indicates information in the first intermediate weight vector that has no impact on feature transmission or has an impact degree, for the feature transmission, less than a specified condition.

6. The method according to claim 5, wherein
obtaining the first intermediate weight vector by processing the feature map through the neural network comprises:
for each feature point in the feature map,
using the feature point as a first input point;
using a surrounding location of the first input point as a first output point corresponding to the first input point, wherein the surrounding location comprises the plurality of the feature points in the feature map and a plurality of adjacent locations of the first input point in a spatial position; and
obtaining a first transmission ratio vector between the first input point and the first output point corresponding to the first input point; and
obtaining the first intermediate weight vector based on the first transmission ratio vector of each feature point; and/or
obtaining the first intermediate weight vector by processing the feature map through the neural network comprises:
before obtaining the first intermediate weight vector by processing the feature map through the neural network, obtaining a first intermediate feature map by performing dimension reduction processing on the feature map through a convolutional layer; and
obtaining the first intermediate weight vector by processing the dimension-reduced first intermediate feature map through the neural network.

7. The method according to claim 6, wherein obtaining the first weight vector by removing the invalid information in the first intermediate weight vector comprises:
identifying, from the first intermediate weight vector, a first transmission ratio vector whose information comprised in the first output point is null;
obtaining the inward reception weights of the feature map by removing, from the first intermediate weight vector, the identified first transmission ratio vector; and
determining the first weight vector based on the inward reception weights.

8. The method according to claim 7, wherein determining the first weight vector based on the inward reception weights comprises:
obtaining the first weight vector by arranging the inward reception weights based on the locations of the corresponding first output points.

9. The method according to claim 4, wherein
obtaining the second weight vector with respect to the outward transmission weights of each of the plurality of the feature points by performing the second branch processing on the feature map comprises:
obtaining a second intermediate weight vector by processing the feature map through a neural network; and
obtaining the second weight vector by removing invalid information in the second intermediate weight vector, wherein the invalid information indicates information in the second intermediate weight vector that has no impact on feature transmission or has an impact degree, for the feature transmission, less than a specified condition; and/or
obtaining the feature-enhanced feature map by separately transmitting feature information of each feature point to the associated other feature points comprised in the feature map based on the corresponding feature weight comprises:
obtaining a first feature vector based on the first weight vector and the feature map;
obtaining a second feature vector based on the second weight vector and the feature map; and
obtaining the feature-enhanced feature map based on the first feature vector, the second feature vector, and the feature map.

10. The method according to claim 9, wherein obtaining the second intermediate weight vector by processing the feature map through the neural network comprises:
for each feature point in the feature map,
using the feature point as a second output point;
using a surrounding location of the second output point as a second input point corresponding to the second output point, wherein the surrounding location comprises the plurality of the feature points in the feature map and a plurality of adjacent locations of the second output point in a spatial position; and
obtaining a second transmission ratio vector between the second output point and the second input point corresponding to the second output point; and
obtaining the second intermediate weight vector based on the second transmission ratio vector of each feature point.

11. The method according to claim 10, wherein obtaining the second weight vector by removing the invalid information in the second intermediate weight vector comprises:
identifying, from the second intermediate weight vector, a second transmission ratio vector whose information comprised in the second output point is null;
obtaining the outward transmission weights of the feature map by removing, from the second intermediate weight vector, the identified second transmission ratio vector; and
determining the second weight vector based on the outward transmission weights.

12. The method according to claim 11, wherein determining the second weight vector based on the outward transmission weights comprises:
obtaining the second weight vector by arranging the outward transmission weights based on the locations of the corresponding second input points.

13. The method according to claim 9, wherein
before obtaining the second intermediate weight vector by processing the feature map through the neural network, the method further comprises:
obtaining a second intermediate feature map by performing dimension reduction processing on the feature map through a convolutional layer; and
obtaining the second intermediate weight vector by processing the feature map through the neural network comprises:
obtaining the second intermediate weight vector by processing the dimension-reduced second intermediate feature map through the neural network.

14. The method according to claim 9, wherein
obtaining the first feature vector based on the first weight vector and the feature map comprises:
obtaining the first feature vector by performing matrix multiplication processing on the first weight vector and the feature map; or
obtaining the first feature vector by performing matrix multiplication processing on the first weight vector and a first intermediate feature map obtained by performing dimension reduction processing on the feature map;
obtaining the second feature vector based on the second weight vector and the feature map comprises:
obtaining the second feature vector by performing matrix multiplication processing on the second weight vector and the feature map; or
obtaining the second feature vector by performing matrix multiplication processing on the second weight vector and a second intermediate feature map obtained by performing dimension reduction processing on the feature map; and/or
obtaining the feature-enhanced feature map based on the first feature vector, the second feature vector, and the feature map comprises:
obtaining a spliced feature vector by splicing the first feature vector and the second feature vector in a channel dimension; and
obtaining the feature-enhanced feature map by splicing the spliced feature vector and the feature map in the channel dimension.

15. The method according to claim 14, wherein
before obtaining the feature-enhanced feature map by splicing the spliced feature vector and the feature map in the channel dimension, the method further comprises:
obtaining a processed spliced feature vector by performing feature projection processing on the spliced feature vector; and
obtaining the feature-enhanced feature map by splicing the spliced feature vector and the feature map in the channel dimension comprises:
obtaining the feature-enhanced feature map by splicing the processed spliced feature vector and the feature map in the channel dimension.

16. The method according to claim 2, wherein the method is implemented by using a feature extraction network and a feature enhancement network; and
before generating the feature map of the to-be-processed image by performing feature extraction on the image, the method further comprises:
training the feature enhancement network by using a sample image, or
training the feature extraction network and the feature enhancement network by using the sample image, wherein the sample image has an annotation processing result which comprises an annotated scene analysis result or an annotated object segmentation result.

17. The method according to claim 16, wherein
training the feature enhancement network by using the sample image comprises:
obtaining a prediction processing result by inputting the sample image into the feature extraction network and the feature enhancement network; and
training the feature enhancement network based on the prediction processing result and the annotation processing result; and/or
training the feature extraction network and the feature enhancement network by using the sample image comprises:
obtaining a prediction processing result by inputting the sample image into the feature extraction network and the feature enhancement network;
obtaining a first loss based on the prediction processing result and the annotation processing result; and
training the feature extraction network and the feature enhancement network based on the first loss.

18. The method according to claim 17, further comprising:
determining an intermediate prediction processing result based on a feature map output by an intermediate layer in the feature extraction network;
obtaining a second loss based on the intermediate prediction processing result and the annotation processing result; and
adjusting parameters of the feature extraction network based on the second loss.

19. An electronic device, comprising:
a processor; and
a memory storing instructions executable by the processor,
wherein the processor is configured to:
generate a feature map of a to-be-processed image by performing feature extraction on the image;
determine a feature weight corresponding to each of a plurality of feature points comprised in the feature map; and
obtain a feature-enhanced feature map by separately transmitting feature information of each feature point to associated other feature points comprised in the feature map based on the corresponding feature weight.

20. A non-volatile computer storage medium storing computer readable instructions that, when executed by a processor, cause the processor to:
generate a feature map of a to-be-processed image by performing feature extraction on the image;
determine a feature weight corresponding to each of a plurality of feature points comprised in the feature map; and
obtain a feature-enhanced feature map by separately transmitting feature information of each feature point to associated other feature points comprised in the feature map based on the corresponding feature weight.
